(19) United States
(12) Patent Application Publication
(10) Pub. No.: US 2011/0242115 A1
(43) Pub. Date: Oct. 6, 2011

(54) METHOD FOR PERFORMING IMAGE SIGNAL PROCESSING WITH AID OF A GRAPHICS PROCESSING UNIT, AND ASSOCIATED APPARATUS

(76) Inventors: You-Ming Tsao, Taipei City (TW); Yu-Chung Chang, Hsinchu County (TW); Yuan-Chung Lee, Tainan City (TW)

(21) Appl. No.: 12/749,527

(22) Filed: Mar. 30, 2010

(51) Int. Cl. G06T 1/00; G06F 9/30

(52) U.S. Cl. 345/522; 712/220; 712/E09.016

(57) ABSTRACT

A method for performing image signal processing (ISP) with the aid of a graphics processing unit (GPU) includes: utilizing an ISP pipeline to perform pre-processing on source data of at least one portion of at least one source frame image to generate intermediate data of at least one portion of at least one intermediate frame image, where the ISP pipeline stores the intermediate data into a memory; and utilizing the GPU to retrieve the intermediate data from the memory and perform specific processing on the intermediate data to generate processed data, where the GPU stores the processed data into the external/on-chip memory. In particular, at least one of the intermediate data and the processed data complies with a specific color format. In addition, an associated apparatus is further provided.

### BACKGROUND

The present invention relates to image signal processing (ISP) such as signal processing of a camera function applied to an image sensor input, and more particularly, to a method for performing ISP with the aid of a graphics processing unit (GPU), and to an associated apparatus.

There are many image processing features such as face detection, object segmentation, high dynamic range processing, etc. available in a conventional ISP system. For example, the ISP system can be implemented within a portable electronic device, such as a digital still image camera (DSC) or a mobile phone device equipped with a camera module. In practice, there are various proposals for implementing the image processing features of the conventional ISP system. A first proposal suggests using a high-end microprocessor to deal with complicated algorithms of these image processing features. However, it is very hard for DSC or mobile phone manufacturers to obtain microprocessors having powerful computation ability from the market at a budget price since some image algorithms are too complicated. In addition, a second proposal suggests using one or more additional dedicated digital signal processors to deal with these complicated algorithms. However, the additional dedicated digital signal processors always lead to more power consumption and more chip area overhead than as usual. Additionally, a third proposal suggests using additional dedicated hardware to deal with these complicated algorithms. However, using the additional dedicated hardware will cause lack of flexibility, and the associated material costs will be increased due to the additional dedicated hardware.

Many problems such as those disclosed above typically occur when implementing various image processing features. Thus, a novel method is desirable for implementing the image processing features of an ISP system in a portable electronic device without introducing serious side effect.

### SUMMARY

It is therefore an objective of the claimed invention to provide a method for performing image signal processing (ISP) with the aid of a graphics processing unit (GPU), and to provide an associated apparatus, in order to solve the above-mentioned problems.

It is another objective of the claimed invention to provide a method for performing ISP with the aid of a GPU, and to provide an associated apparatus, in order to establish and utilize cooperation means between a GPU system and an ISP system respectively having their operations originally independent of each other, and to achieve high overall performance accordingly.

An exemplary embodiment of a method for performing ISP with aid of a GPU comprises: utilizing an ISP pipeline to perform pre-processing on source data of at least one portion of at least one source frame image, wherein the pre-processing comprises storing into a memory; and utilizing the GPU to retrieve data from the memory and perform specific processing on the retrieved data to generate processed data, wherein the GPU stores the processed data into the memory. In addition, at least one of the retrieved data and the processed data complies with a specific data structure. For example, the specific data structure may comprise a kind of color format attribute such as a YUV format for video, an RGB format for computer, or a RAW format. In another example, the specific data structure may comprise specific information such as motion vector information or feature point information.

An exemplary embodiment of an apparatus for performing ISP comprises an ISP pipeline and a GPU. The ISP pipeline is arranged to perform pre-processing on source data of at least one portion of at least one source frame image, wherein the pre-processing comprises storing into a memory of the apparatus. In addition, the GPU is arranged to retrieve data from the memory and perform specific processing on the retrieved data to generate processed data, wherein the GPU stores the processed data into the memory. Additionally, at least one of the retrieved data and the processed data complies with a specific data structure. For example, the specific data structure may comprise a kind of color format attribute such as a YUV format for video, an RGB format for computer, or a RAW format. In another example, the specific data structure may comprise specific information such as motion vector information or feature point information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a block diagram of an apparatus for performing image signal processing (ISP) according to a first embodiment of the present invention.

FIG. 1B is a software stack illustration of the apparatus shown in FIG. 1A according to an embodiment of the present invention.

FIG. 2 is a flowchart of a method for performing ISP with the aid of a graphics processing unit (GPU) according to an embodiment of the present invention.

FIG. 3 illustrates a plurality of tiles involved with the method shown in FIG. 2 according to an embodiment of the present invention.

FIG. 4 illustrates operations of a synchronization controller involved with the method shown in FIG. 2 according to an embodiment of the present invention, where the synchronization controller can be referred to as the syncker for brevity.

FIGS. 5A-5B illustrate some operations performed in a plurality of phases involved with the method shown in FIG. 2 according to different embodiments of the present invention.

FIGS. 6A-6B illustrate some operations performed in a plurality of phases involved with the method shown in FIG. 2 according to different embodiments of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

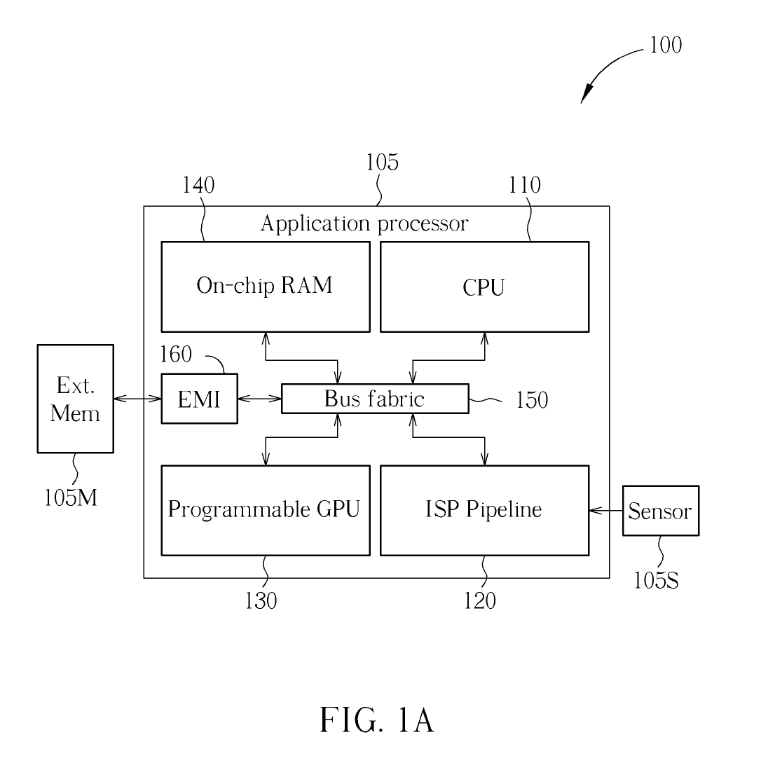

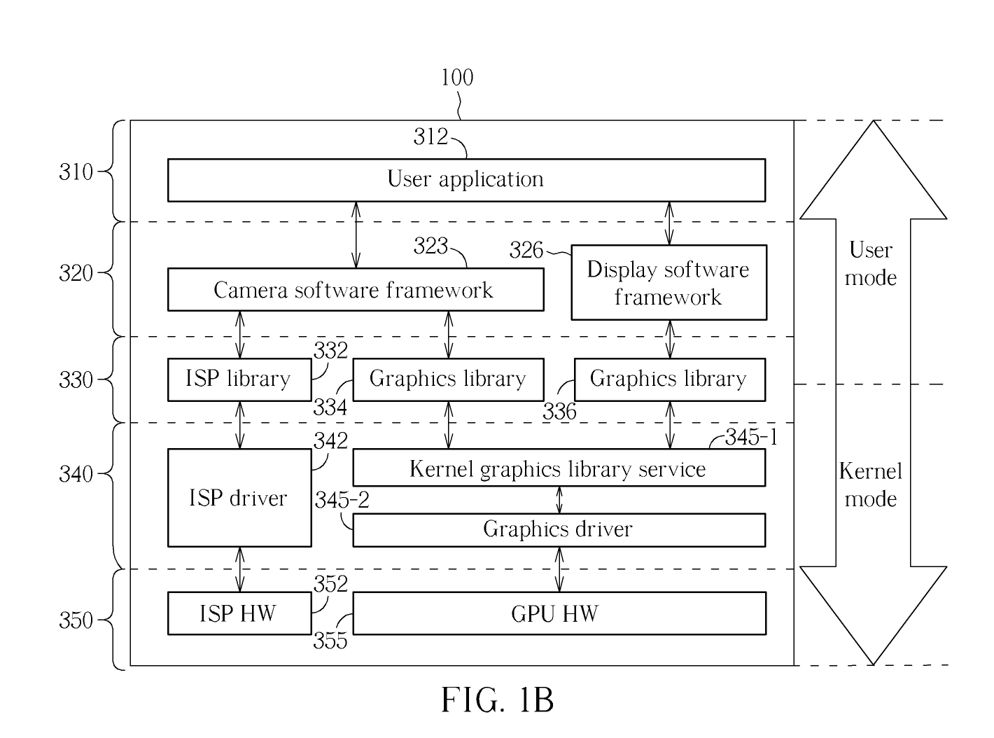

Please refer to FIG. 1A, which illustrates a block diagram of an apparatus 100 for performing image signal processing (ISP) according to a first embodiment of the present invention. The apparatus 100 comprises an application processor 105, which can be implemented with a single chip in this embodiment, and further comprises an external memory 105M (labeled “Ext. Mem” in FIG. 1A) and an image sensor 105S (labeled “Sensor” in FIG. 1A for simplicity). As shown in FIG. 1A, the application processor 105 of the apparatus 100 comprises a central processing unit (CPU) 110, an ISP pipeline 120, a graphics processing unit (GPU) such as a programmable GPU 130, an on-chip memory such as an on-chip random access memory (RAM) 140, a bus fabric 150, and an external memory interface 160 (labeled “EMI” in FIG. 1A). This is for illustrative purposes only, and is not meant to be a limitation of the present invention. According to a variation of this embodiment, the application processor 105 can be regarded as the apparatus 100, where the image sensor 105S and the external memory 105M can be regarded as external components positioned outside the apparatus 100.

In the first embodiment, the CPU 110 is arranged to control operations of the apparatus 100, and the ISP pipeline 120 is arranged to perform ISP operations, where the image sensor 105S can be a signal source of the ISP pipeline 120. In addition, the programmable GPU 130 can be utilized for performing complicated calculations such as those of the complicated algorithms mentioned above, and the on-chip RAM 140 and the external memory 105M can be utilized for storing information. Additionally, the bus fabric 150 is a bus arranged to electrically connect the respective components within the application processor 105, and the external memory interface 160 is an interface between the bus fabric 150 and the external memory 105M.

According to this embodiment, high overall performance of the apparatus 100 can be achieved with the aid of establishing and utilizing cooperation means between a GPU system (e.g. the programmable GPU 130) and an ISP system (e.g. the ISP pipeline 120) respectively having their operations originally independent of each other. FIG. 1B is a software stack illustration of the apparatus 100 shown in FIG. 1A according to an embodiment of the present invention. The cooperation means mentioned above can be illustrated with at least a portion of a plurality of software layers of the apparatus 100, and more particularly, a portion or all of respective software modules in the software layers. As shown in FIG. 1B, the software layers may comprise an application layer 310, a framework layer 320, a library layer 330, and a driver layer 340, where a hardware layer 350 is also illustrated for better comprehension.

In this embodiment, the application layer 310 comprises a user application 312, while the framework layer 320 comprises an ISP application framework such as a camera software framework 323 arranged to control ISP operations applied to an image signal obtained from the image sensor 105S, and further comprises a display software framework 326 arranged to control display operations of the apparatus 100, such as user interface (UI) animations. In addition, the library layer 330 comprises an ISP library 332 and further comprises two graphics libraries 334 and 336 respectively corresponding to the ISP application framework (e.g. the camera software framework 323) and the display software framework 326, while the driver layer 340 comprises an ISP driver 342 and further comprises one graphics library service such as a kernel graphics library service 345-1 and a hardware driver such as a graphics driver 345-2. Please note that the two graphics libraries 334 and 336 can be regarded as two graphics contexts for the user. Additionally, the hardware layer 350 comprises an ISP hardware module 352 (labeled “ISP HW” in FIG. 1B) comprising hardware circuits of the ISP pipeline 120 shown in FIG. 1A, and further comprises a GPU hardware module 355 (labeled “GPU HW” in FIG. 1B) comprising hardware circuits of the programmable GPU 130 shown in FIG. 1A.

In particular, the hardware modules in the hardware layer 350 and the software modules in the driver layer 340 operate in a kernel mode, and the software modules in the upper two layers 310 and 320 shown in FIG. 1B operate in a user mode. In addition, the ISP driver 342 is arranged to control the hardware circuits of the ISP pipeline 120, and the graphics driver 345-2 is arranged to control the hardware circuits of the programmable GPU 130, where both the ISP driver 342 and the graphics driver 345-2 operate under control of the aforementioned ISP application framework such as the camera software framework 323, and the graphics driver 345-2 further operates under control of the display software framework 326. Please note that the aforementioned graphics library service such as the kernel graphics library service 345-1 is arranged to provide the two graphics libraries 334 and 336 with services from the graphics driver 345-2. When needed, the ISP driver 342 of this embodiment can communicate with the kernel graphics library service 345-1 to synchronize between the ISP driver 342 and the graphics driver 345-2. According to this embodiment, the graphics library 336 is dedicated for UI animations under control of the display software framework 326, no path is designated between the ISP library 332 and the graphics library 336. Based upon the architecture disclosed above, there is no need to synchronize between the ISP driver 342 and the graphics driver 345-2.

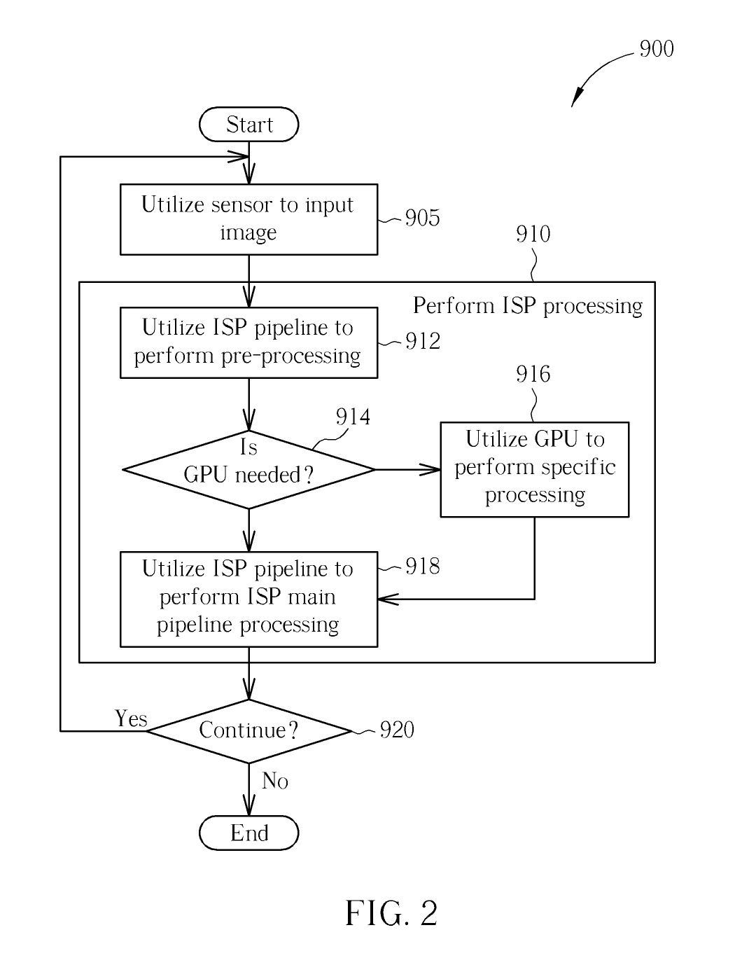

By utilizing the architecture shown in FIG. 1B, the cooperation means mentioned above can be established with ease, having no need to change any of the display software framework 326 and the graphics library 336 or change the associated display system of the apparatus 100. Therefore, the related art problems such as the trade-off between the price and the computation ability of the microprocessors is no longer an issue since there is no need to use a high-end microprocessor for dealing with the aforementioned complicated algorithms. In addition, the problem of introducing more power consumption and more chip area overhead can also be solved since no additional dedicated digital signal processor for dealing with the aforementioned complicated algorithms is required. Additionally, the related art problems such as increased material costs and lack of flexibility is no longer an issue since no additional dedicated hardware for dealing with the aforementioned complicated algorithms is required. Referring to FIG. 2, more details are further described as follows.

FIG. 2 is a flowchart of a method 900 for performing ISP with the aid of a GPU according to an embodiment of the present invention. The method 900 can be applied to the apparatus 100 shown in FIG. 1A, and more particularly, to the CPU 110 equipped with the software modules in the architecture shown in FIG. 1B. In addition, the method 900 can be implemented by utilizing the apparatus 100 shown in FIG. 1A, and more particularly, by utilizing the CPU 110 equipped with the software modules in the architecture shown in FIG. 1B. The method 900 is described as follows.

In Step 905, a sensor such as the aforementioned image sensor 105S in the apparatus 100 is utilized to generate and input an image signal into the application processor 105. More particularly, under control of the CPU 110, the apparatus 100 obtains the aforementioned image signal from the image sensor 105S.

In Step 910, the apparatus 100 performs ISP processing, where Step 910 of this embodiment comprises Step 912, Step 914, Step 916, and Step 918. The implementation details thereof are described as follows.

In Step 912, the apparatus 100 utilizes the ISP pipeline 120 to perform pre-processing. In particular, under control of the CPU 110, the apparatus 100 utilizes the ISP pipeline 120 to perform pre-processing or front end processing on source data of at least one portion of at least one source frame image. For example, the ISP pipeline 120 may store the data into an external/on-chip memory. In details, with the aid of the external memory interface 160, the ISP pipeline 120 stores the source data into the external memory 105M through the bus fabric 150. In another example, the ISP pipeline 120 stores the source data into the on-chip RAM 140 through the bus fabric 150. In some embodiments, the ISP pipeline 120 performs pre-processing to generate intermediate data of at least one portion of at least one intermediate frame image, and stores the intermediate data into an external/on-chip memory.

In this embodiment, the source data is obtained from the image sensor 105S positioned within the apparatus 100, where the image sensor 105S can be implemented in a camera module embedded within the apparatus 100. This is for illustrative purposes only, and is not meant to be a limitation of the present invention. According to a variation of this embodiment, in a situation where the image sensor 105S is implemented within an individual camera module, rather than being positioned within the apparatus 100, the source data is obtained from the image sensor 105S positioned outside the apparatus 100. According to another variation of this embodiment, the CPU 110 is further arranged to generate the source data.

In Step 914, the apparatus 100 determines whether a GPU such as the programmable GPU 130 is needed. The camera software framework 323 will get the image processing feature information from an application and determine if the features represented by the image processing feature information are performed by the programmable GPU 130. When it is determined that an image feature is implemented in the programmable GPU 130, Step 916 is entered; otherwise, Step 918 is entered. From the ISP pipeline point of view, the programmable GPU 130 can be treated like an internal pipeline stage in the ISP pipeline 120.

In Step 916, the apparatus 100 utilizes the aforementioned GPU to perform specific processing, where the specific processing can be implemented with program codes for carrying out some image processing features such as those mentioned above. In particular, under control of the CPU 110, the apparatus 100 utilizes the aforementioned GPU such as the programmable GPU 130 to retrieve the data (e.g. source/intermediate data) from the external/on-chip memory (e.g. the external memory 105M or the on-chip RAM 140) and perform the specific processing on the data to generate processed data, where the GPU may store the processed data into the external/on-chip memory. In this embodiment, at least one of the source/intermediate data and the processed data (e.g. a portion or all of the intermediate data and the processed data) complies with a specific data structure. For example, the specific data structure can be a kind of color format attribute such as a YUV format for video, an RGB format for computer, or a RAW format. In another example, the specific data structure can be specific information such as motion vector information (e.g. the motion vector of a video frame) or feature point information (e.g. the features point of an object).

In Step 918, the apparatus 100 utilizes the ISP pipeline 120 to perform ISP main pipeline processing, and more particularly, utilizes the ISP pipeline 120 to retrieve the processed data from the external/on-chip memory (e.g. the external memory 105M or the on-chip RAM 140) and perform ISP main pipeline processing on the processed data.

In Step 920, the apparatus 100 determines whether to continue the ISP operations. When it is determined to continue the ISP operations, Step 905 is re-entered; otherwise, the working flow shown in FIG. 2 is ended.

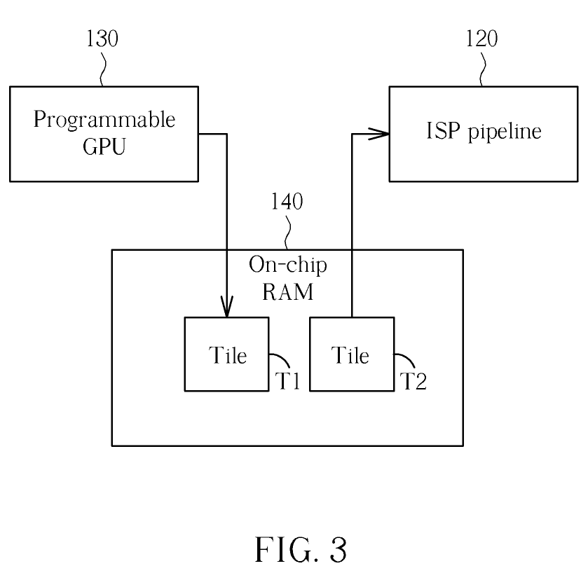

According to this embodiment, the aforementioned at least one portion of the at least one source frame image (e.g. one or more source frame images) comprises a whole image of the at least one source frame image, and the ISP pipeline 120 performs the pre-processing on the source data in units of whole images. In addition, the aforementioned at least one portion of the at least one intermediate frame image comprises a whole image of the at least one intermediate frame image, and the aforementioned GPU such as the programmable GPU 130 performs the specific processing on the source/intermediate data in units of whole images. This is for illustrative purposes only, and is not meant to be a limitation of the present invention. According to variations of this embodiment, such as the embodiment shown in FIG. 3, the aforementioned at least one portion of the at least one source frame image comprises a partial image of the at least one source frame image, and the ISP pipeline 120 performs the pre-processing on the source data in units of partial images, such as a plurality of tiles divided from one or more source frame images. In addition, the aforementioned at least one portion of the at least one intermediate frame image comprises a partial image of the at least one intermediate frame image, and the aforementioned GPU such as the programmable GPU 130 performs the specific processing on the source/intermediate data in units of partial images, such as a plurality of tiles divided from one or more intermediate frame images. As a result of processing in units of partial images, the required buffering space can be reduced.

FIG. 3 illustrates a plurality of tiles (e.g. the tiles T1 and T2) involved with the method 900 shown in FIG. 2 according to an embodiment of the present invention. In this embodiment, the programmable GPU 130 shown in FIG. 1A performs the aforementioned specific processing on the intermediate data in units of partial images. For example, each source frame image is divided into four tiles, such as an upper left quarter, an upper right quarter, a lower left quarter, and a lower right quarter of the source frame image, while each intermediate frame image is divided into four tiles, such as an upper left quarter, an upper right quarter, a lower left quarter, and a lower right quarter of the intermediate frame image. In another example, each source frame image is divided into two tiles, such as an upper half and a lower half of the source frame image, while each intermediate frame image is divided into two tiles, such as an upper half and a lower half of the intermediate frame image. The tile Ti shown in FIG. 3 may represent a tile that is currently stored into the on-chip RAM 140 by the programmable GPU 130 in Step 916, and the tile T2 shown in FIG. 3 may represent a previously stored tile that is currently read by the ISP pipeline 120 in Step 918.

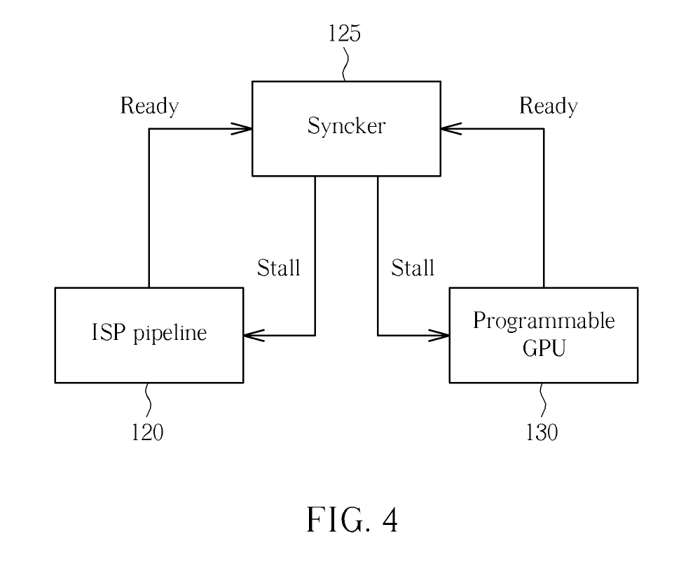

FIG. 4 illustrates operations of a synchronization controller 125 involved with the method 900 shown in FIG. 2 according to an embodiment of the present invention, where the synchronization controller 125 can be referred to as the syncker for brevity, and is therefore labeled “Syncker” in FIG. 4. The synchronization controller 125 is arranged to perform hardware handshaking, in order to reduce overhead due to software operations.

For example, the synchronization controller 125 may send a stall signal (labeled “Stall” in FIG. 4) to the programmable GPU 130 when the intermediate data mentioned in Step 916 is not ready for the specific processing, and the programmable GPU 130 may send a ready signal (labeled “Ready” in FIG. 4) to the synchronization controller 125 when the programmable GPU 130 completes an operation of the specific processing with respect to the intermediate data being processed in Step 916. Regarding the pre-processing mentioned in Step 912, the synchronization controller 125 may send a stall signal (labeled “Stall” in FIG. 4) to the ISP pipeline 120 when the source data is not ready for the pre-processing, and the ISP pipeline 120 may send a ready signal (labeled “Ready” in FIG. 4) to the synchronization controller 125 when the ISP pipeline 120 completes an operation of the pre-processing with respect to the source data being processed in Step 912. Similarly, regarding the ISP main pipeline processing mentioned in Step 918, the synchronization controller 125 may send a stall signal (labeled “Stall” in FIG. 4) to the ISP pipeline 120 when the processed data is not ready for the ISP main pipeline processing, and the ISP pipeline 120 may send a ready signal (labeled “Ready” in FIG. 4) to the synchronization controller 125 when the ISP pipeline 120 completes an operation of the ISP main pipeline processing with respect to the data being processed in Step 918. As a result of utilizing the synchronization controller 125, implementation of the architecture shown in FIG. 1B will not cause an increased workload of the CPU 110.

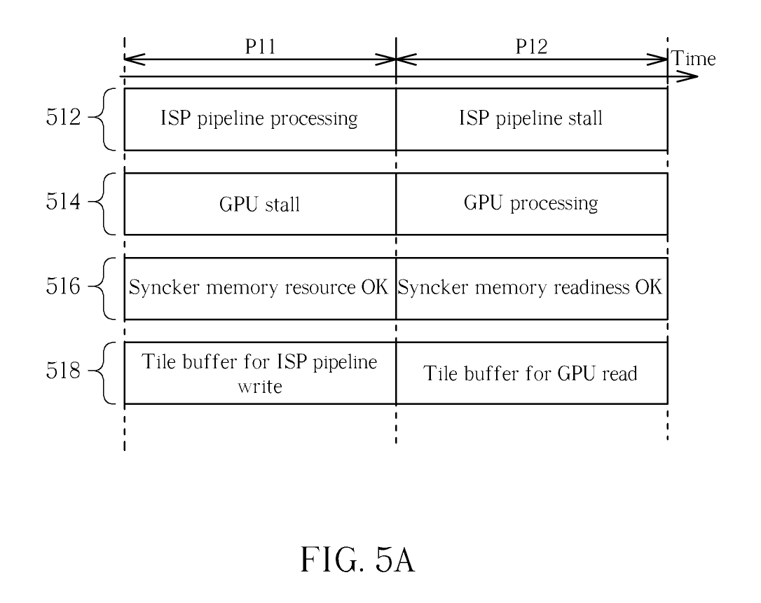

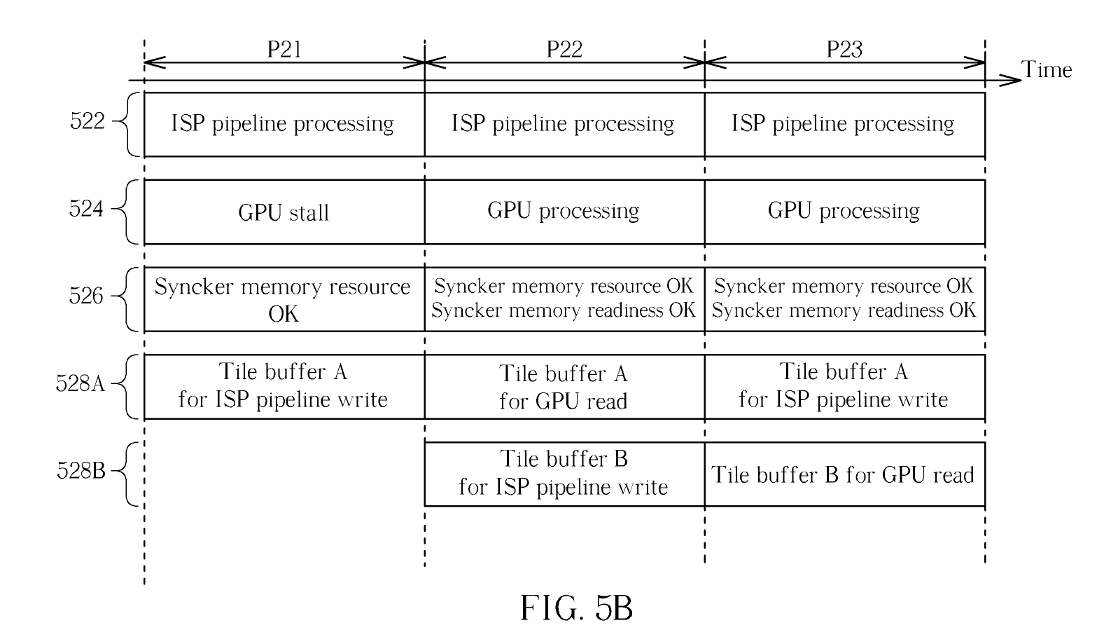

FIGS. 5A-5B illustrate some operations performed in a plurality of phases (e.g. the phases P11 and P12, or the phases P21, P22, and P23) involved with the method 900 shown in FIG. 2 according to different embodiments of the present invention, where the hardware handshaking of the aforementioned synchronization controller 125 (labeled “Syncker” in FIG. 4) can be applied to these embodiments.

According to the embodiment shown in FIG. 5A, a single tile buffer within the external/on-chip memory mentioned above is arranged to temporarily store one of a plurality of tiles at a time. As shown in FIG. 5A, multiple rows of states 512, 514, 516, and 518 are illustrated for respectively indicating the states of the ISP pipeline 120, the programmable GPU 130, the synchronization controller 125, and the tile buffer.

During the phase P11, the ISP pipeline processing is performed with the programmable GPU 130 being in a GPU stall state (labeled “GPU stall” in FIG. 5A), and the synchronization controller 125 registers the required memory resource (i.e. the single tile buffer) for the ISP pipeline processing and inactivates the stall signal for the ISP pipeline 120, indicating a “Syncker memory resource OK” state for the ISP pipeline 120 in the phase P11. In this situation, the tile buffer is utilized for ISP pipeline write, and is in a “Tile buffer for ISP pipeline write” state. In addition, during the phase P12, the GPU processing is performed with the ISP pipeline 120 being in an ISP pipeline stall state (labeled “ISP pipeline stall” in FIG. 5A). When receiving the ready signal from the ISP pipeline 120 due to finishing writing the tile buffer, the synchronization controller 125 registers the readiness of the tile buffer, indicating a “Syncker memory readiness OK” state for the tile buffer. In this situation, the tile buffer is utilized for GPU read, and is in a “Tile buffer for GPU read” state.

In some embodiments, during a phase P13 (not shown in FIG. 5A) that comes after the phase P12, the GPU processing is performed with the ISP pipeline 120 being in a ISP pipeline stall state, and the synchronization controller 125 registers the required memory resource (i.e. the single tile buffer) for the GPU processing and inactivates the stall signal for the programmable GPU 130, indicating a “Syncker memory resource OK” state for the programmable GPU 130 in the phase P13. In this situation, the tile buffer is utilized for GPU write, and is in a “Tile buffer for GPU write” state. In addition, during a phase P14 (not shown in FIG. 5A) that comes after the phase P13, the ISP pipeline processing is performed with the programmable GPU 130 being in a GPU stall state. When receiving the ready signal from the programmable GPU 130 due to finishing writing the tile buffer, the synchronization controller 125 registers the readiness of the tile buffer, indicating a “Syncker memory readiness OK” state for the tile buffer. In this situation, the tile buffer is utilized for ISP pipeline read, and is in a “Tile buffer for ISP pipeline read” state. In this embodiment, the phases P11, P12, P13 and P14 can be repeated, and the respective operations in the phases P11, P12, P13 and P14 may occur in turns.

According to the embodiment shown in FIG. 5B, multiple tile buffers such as two tile buffers (e.g. tile buffers A and B) within the external/on-chip memory mentioned above are arranged to temporarily store two of a plurality of tiles at a time. As shown in FIG. 5B, multiple rows of states 522, 524, 526, 528A, and 528B are illustrated for respectively indicating the states of the ISP pipeline 120, the programmable GPU 130, the synchronization controller 125, and the tile buffers A and B.

During the phase P21, the ISP pipeline processing is performed with the programmable GPU 130 being in a GPU stall state (labeled “GPU stall” in FIG. 5A), and the synchronization controller 125 registers the required memory resource (e.g. the tile buffer A) for the ISP pipeline processing and inactivates the stall signal for the ISP pipeline 120, indicating a “Syncker memory resource OK” state for the ISP pipeline 120 in the phase P21. In this situation, the tile buffer A is utilized for ISP pipeline write, and is in a “Tile buffer A for ISP pipeline write” state.

In addition, during the phase P22, the GPU processing is performed while the ISP pipeline processing is also performed, and the synchronization controller 125 registers the required memory resource (e.g. the tile buffer B) for the GPU processing and inactivates the stall signal for the programmable GPU 130, indicating a “Syncker memory resource OK” state for the programmable GPU 130 in the phase P22. When receiving the ready signal from the ISP pipeline 120 due to finishing writing the tile buffer A, the synchronization controller 125 registers the readiness of the tile buffer A, indicating a “Syncker memory readiness OK” state for the tile buffer A. In this situation, the tile buffer A is utilized for GPU read, and is in a “Tile buffer A for GPU read” state. In addition, the tile buffer B is utilized for ISP pipeline write, and is in a “Tile buffer B for ISP pipeline write” state.

Similarly, during the phase P23, the GPU processing is performed while the ISP pipeline processing is also performed, and the synchronization controller 125 registers the required memory resource (e.g. the tile buffer A) for the ISP pipeline processing and inactivates the stall signal for the ISP pipeline 120, indicating a “Syncker memory resource OK” state for the ISP pipeline 120 in the phase P23. When receiving the ready signal from the programmable GPU 130 due to finishing writing the tile buffer B, the synchronization controller 125 registers the readiness of the tile buffer B, indicating a “Syncker memory readiness OK” state for the tile buffer B. In this situation, the tile buffer B is utilized for GPU read, and is in a “Tile buffer B for GPU read” state. In addition, the tile buffer A is utilized for ISP pipeline write, and is in a “Tile buffer A for ISP pipeline write” state. In this embodiment, the phases P22 and P23 can be repeated, and the respective operations in the phases P22 and P23 may occur alternatively.

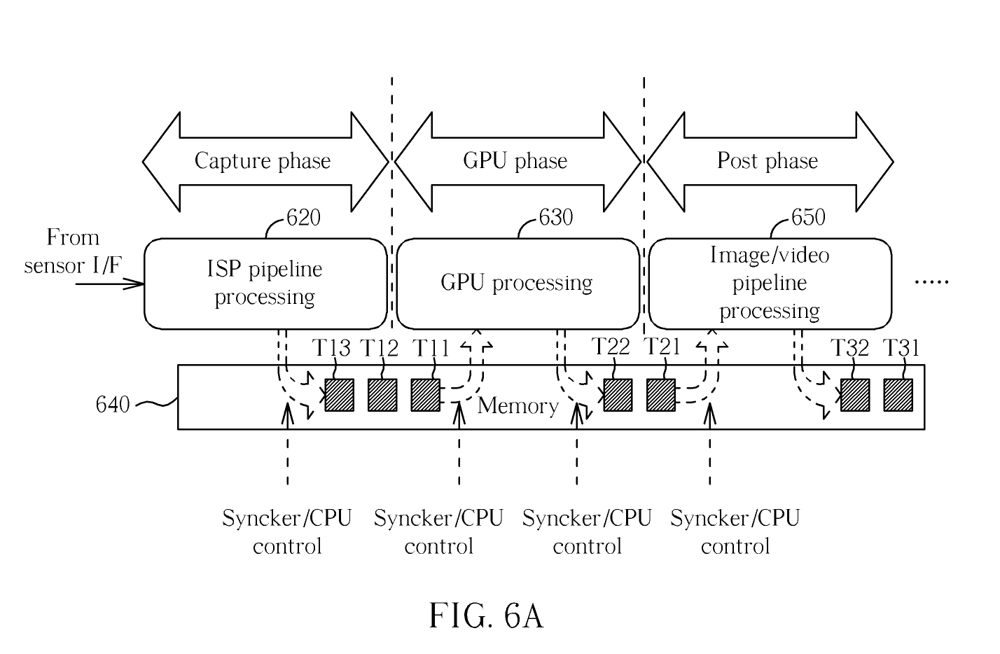

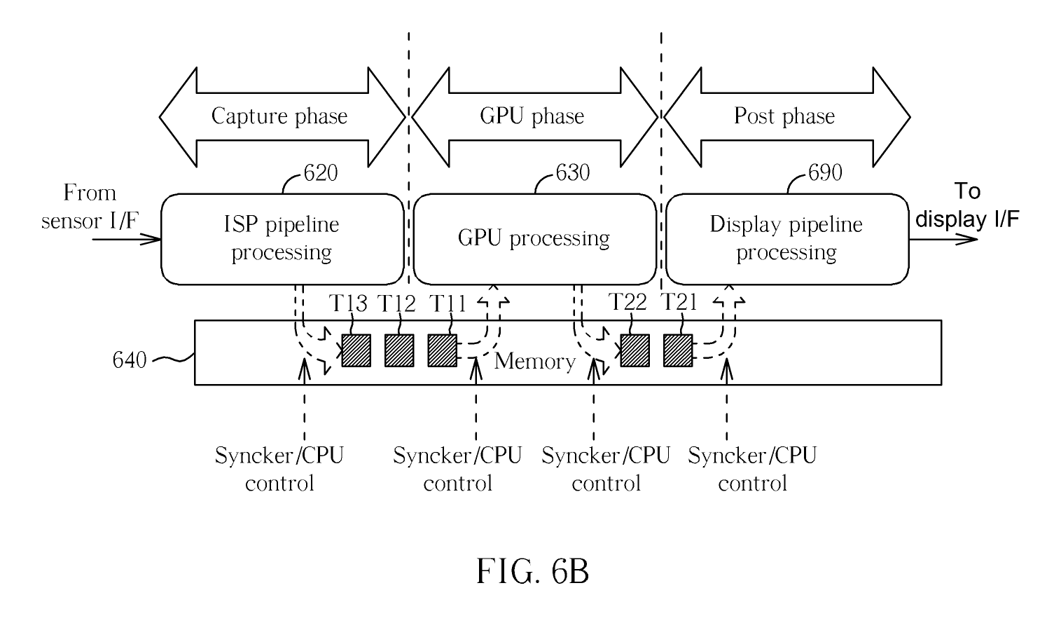

FIGS. 6A-6B illustrate some operations performed in a plurality of phases (e.g. the capture phase, the GPU phase, and the post phase) involved with the method 900 shown in FIG. 2 according to different embodiments of the present invention, where each of these embodiments is a variation of the embodiment shown in FIG. 5B. The memory 640 represents the external/on-chip memory mentioned above. In addition, the phases of this embodiment can be overlapped along the time axis. Please note that, based upon different variations, the hardware handshaking of the aforementioned synchronization controller 125 (labeled “Syncker” in FIG. 4), or the associated software control without using the synchronization controller 125, can be applied to these embodiments, which means the access to the memory 640 can be controlled by the synchronization controller 125 or the CPU 110. Therefore, in general, the control over the access to the memory 640 can be labeled “Syncker/CPU control” in FIGS. 6A-6B.

In the embodiment shown in FIG. 6A, the ISP pipeline processing 620 is performed in the capture phase with the input thereof being received from the sensor interface (I/F) of the image sensor 105S. In addition, the GPU processing 630 is performed in the GPU phase, and the image/video pipeline processing 650 is performed in the post phase. Here, the tiles T11, T12, T13, etc. are taken as examples of the tiles that the ISP pipeline processing 620 passes to the GPU processing 630 through the buffering space (e.g. the tile buffers) of the memory 640, and the tiles T21, T22, etc. are taken as examples of the tiles that the GPU processing 630 passes to the image/video pipeline processing 650 through the buffering space (e.g. the tile buffers) of the memory 640, while the tiles T31, T32, etc. are taken as examples of the tiles that the image/video pipeline processing 650 passes to the subsequent processing through the buffering space (e.g. the tile buffers) of the memory 640. Similar descriptions are not repeated for this variation.

The embodiment shown in FIG. 6B is a variation of the embodiment shown in FIG. 6A, where the apparatus 100 comprises a display system such as that mentioned above. The apparatus 100 utilizes the display system to retrieve the processed data from the external/on-chip memory mentioned above (e.g. the external memory 105M or the on-chip RAM 140), in order to display the processed data. Thus, the image/video pipeline processing 650 mentioned above is replaced by the display pipeline processing 690 in this embodiment with the output thereof being sent to the display interface (I/F) of the display system. Similar descriptions are not repeated for this variation.

It is an advantage of the present invention that the present invention method and the associated apparatus can be implemented with ease, having no need to change any of the display software framework 326 and the graphics library 336 or change the associated display system of the apparatus 100. Therefore, the related art problems, such as the trade-off between the price and the computation ability of the microprocessors, more power consumption and more chip area overhead than as usual, and increased material costs and lack of flexibility, will never occur.

In addition, as the aforementioned GPU such as the programmable GPU 130 is typically a highly parallel processor, and as the performance thereof is typically several times faster than the system CPU such as the CPU 110, the embodiments disclosed above can off-load the CPU workload without introducing addition costs. Additionally, the GPU of the embodiments disclosed above is programmable, causing better flexibility than that of the related art architecture having dedicated hardware therein.

Those skilled in the art will readily observe that numerous modifications and alterations of the device and method may be made while retaining the teachings of the invention.

What is claimed is:

1. A method for performing image signal processing (ISP) with aid of a graphics processing unit (GPU), the method comprising:
utilizing an ISP pipeline to perform pre-processing on source data of at least one portion of at least one source frame image, wherein the pre-processing comprises storing into a memory; and
utilizing the GPU to retrieve data from the memory and perform specific processing on the retrieved data to generate processed data, wherein the GPU stores the processed data into the memory;
wherein at least one of the retrieved data and the processed data complies with a specific data structure.

2. The method of claim 1, wherein the source data is obtained from an image sensor positioned within or outside an apparatus comprising the ISP pipeline and the GPU.

3. The method of claim 1, wherein an apparatus comprising the ISP pipeline and the GPU further comprises a central processing unit (CPU) arranged to control operations of the apparatus; and the CPU is further arranged to generate the source data.

4. The method of claim 1, further comprising:
utilizing the ISP pipeline to retrieve the processed data from the memory and perform ISP main pipeline processing on the processed data.

5. The method of claim 1, wherein an apparatus comprising the ISP pipeline and the GPU further comprises a display system; and the method further comprises:
utilizing the display system to retrieve the processed data from the memory, in order to display the processed data.

6. The method of claim 1, wherein the at least one portion of the at least one source frame image comprises a whole image of the at least one source frame image, and the ISP pipeline performs the pre-processing on the source data in units of whole images; and the at least one portion of the at least one retrieved frame image comprises a whole image of the retrieved frame image, and the GPU performs the specific processing on the retrieved data in units of whole images.

7. The method of claim 1, wherein the at least one portion of the at least one source frame image comprises a partial image of the at least one source frame image, and the ISP pipeline performs the pre-processing on the source data in units of partial images; and the at least one portion of the at least one retrieved frame image comprises a partial image of the retrieved frame image, and the GPU performs the specific processing on the retrieved data in units of partial images.

8. The method of claim 1, wherein a driver layer of a plurality of software layers of an apparatus comprising the ISP pipeline and the GPU comprises:
an ISP driver arranged to control hardware circuits of the ISP pipeline; and
a graphics driver arranged to control hardware circuits of the GPU;
wherein both the ISP driver and the graphics driver operate under control of an ISP application framework in a framework layer of the plurality of software layers.

9. The method of claim 8, wherein the software layers further comprise a library layer between the framework layer and the driver layer, and the library layer comprises two graphics libraries respectively corresponding to the ISP application framework and a display software framework in the framework layer; and the driver layer further comprises:
a graphics library service arranged to provide the two graphics libraries with services from the graphics driver;
wherein the ISP driver is further arranged to communicate with the graphics library service to synchronize between the ISP driver and the graphics driver; and the graphics driver further operates under control of the display software framework.

10. The method of claim 1, wherein the specific data structure comprises a color format attribute, motion vector information, or feature point information.

11. An apparatus for performing image signal processing (ISP), the apparatus comprising:
an ISP pipeline arranged to perform pre-processing on source data of at least one portion of at least one source frame image, wherein the pre-processing comprises storing into a memory of the apparatus; and
a graphics processing unit (GPU) arranged to retrieve data from the memory and perform specific processing on the retrieved data to generate processed data, wherein the GPU stores the processed data into the memory;
wherein at least one of the retrieved data and the processed data complies with a specific data structure.

12. The apparatus of claim 11, wherein the source data is obtained from an image sensor positioned within or outside the apparatus.

13. The apparatus of claim 11, further comprising:
a central processing unit (CPU) arranged to control operations of the apparatus, wherein the CPU is further arranged to generate the source data.

14. The apparatus of claim 11, wherein the ISP pipeline is further arranged to retrieve the processed data from the memory and perform ISP main pipeline processing on the processed data.

15. The apparatus of claim 11, further comprising:
a display system arranged to retrieve the processed data from the memory, in order to display the processed data.

16. The apparatus of claim 11, wherein the at least one portion of the at least one source frame image comprises a whole image of the at least one source frame image, and the ISP pipeline performs the pre-processing on the source data in units of whole images; and the at least one portion of the at least one retrieved frame image comprises a whole image of the retrieved frame image, and the GPU performs the specific processing on the retrieved data in units of whole images.

17. The apparatus of claim 11, wherein the at least one portion of the at least one source frame image comprises a partial image of the at least one source frame image, and the ISP pipeline performs the pre-processing on the source data in units of partial images; and the at least one portion of the at least one retrieved frame image comprises a partial image of the retrieved frame image, and the GPU performs the specific processing on the retrieved data in units of partial images.

18. The apparatus of claim 11, wherein a driver layer of a plurality of software layers of the apparatus comprises:
an ISP driver arranged to control hardware circuits of the ISP pipeline; and
a graphics driver arranged to control hardware circuits of the GPU;
wherein both the ISP driver and the graphics driver operate under control of an ISP application framework in a framework layer of the plurality of software layers.

19. The apparatus of claim 18, wherein the software layers further comprise a library layer between the framework layer and the driver layer, and the library layer comprises two graphics libraries respectively corresponding to the ISP application framework and a display software framework in the framework layer; and the driver layer further comprises:
a graphics library service arranged to provide the two graphics libraries with services from the graphics driver;
wherein the ISP driver is further arranged to communicate with the graphics library service to synchronize between the ISP driver and the graphics driver; and the graphics driver further operates under control of the display software framework.

20. The apparatus of claim 11, wherein the specific data structure comprises a color format attribute, motion vector information, or feature point information.
